(19) United States
(12) Patent Application Publication
(10) Pub. No.: US 2009/0112997 A1
(43) Pub. Date: Apr. 30, 2009

(54) Utilizing Presence Data Associated with Web Item

(75) Inventors: Carey B. Parker, II, Morrisville, NC (US); Sean M. Whitsell, Chapel Hill, NC (US); Michael J. Lemen, Durham, NC (US); Marshall B. Ross, Apex, NC (US); William L. McKinley, Hillsborough, NC (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/923,951

(22) Filed: Oct. 25, 2007

(51) Int. Cl. G06F 15/16

(52) U.S. Cl. 709/206; 709/217

(57) ABSTRACT

In one embodiment, a method includes subscribing to a web item, extracting presence data from the web item, receiving the presence data originating from the web item. The method includes updating status associated with the web item based on the presence data and displaying the updated status associated with the web item.

### TECHNICAL FIELD

The present disclosure relates generally to communication applications.

### BACKGROUND

As the communication methods available to end users increase, efficient management of utilizing these communication methods becomes even more critical. Many end users are overloaded and overwhelmed with various communication devices and applications. Thus, the ability to efficiently manage and combine these multiple communication methods presents a significant challenge to designers and end users. Unified communications enhance abilities of end users to collaborate and be more productive with other end users.

### BRIEF DESCRIPTION OF THE DRAWINGS

FIG. 1 illustrates an example system for utilizing presence data associated with web item;

FIG. 2 illustrates a simplified block diagram of an interface of the unified personal communicator;

FIG. 3 illustrates an example method for utilizing presence data associated with web item; and

FIG. 4 illustrates an example method for utilizing presence data associated with web item.

### DESCRIPTION OF EXAMPLE EMBODIMENTS

### Overview

In one embodiment, a method includes subscribing to a web item, extracting presence data from the web item, receiving the presence data originating from the web item. The method includes updating status associated with the web item based on the presence data and displaying the updated status associated with the web item.

### Description

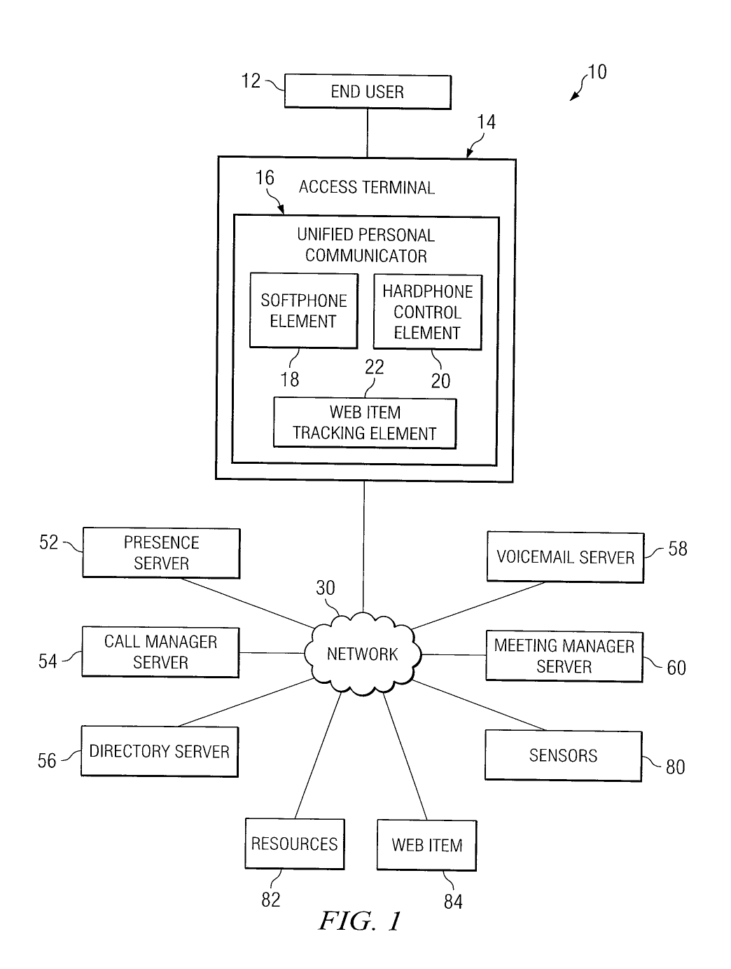

FIG. 1 is a simplified block diagram of a communication system 10 for utilizing presence data associated with web item. Communication system 10 includes an end user 12, an access terminal 14, a communication network 30, a presence server 52, a call manager server 54, a directory server 56, a voicemail server 58, a meeting manager server 60, sensors 80, resources 82, and web item 84. Access terminal 14 may include a unified personal communicator 16. Unified personal communicator 16 may include a softphone element 18, a hardphone control element 20, and a web item tracking element 22.

In accordance with the teachings of the present disclosure, communication system 10 operates to utilize presence data associated with web item 84. Web items 84 are described in more detail below. Web item tracking element 22 allows end users 12 to subscribe to web item 84, receive presence data originating from web item 84, update status of web item 84, and display the status of web item 84 to end user 12. Web item tracking element 22 allows end user 12 to customize display of buddy representing web item 84, such that display status may change based on the received presence data. Web item tracking element 22 allows end user 12 to create triggering events based on presence data originating from web item 84. Web item tracking element 22 generates an event if the triggering event is satisfied.

Important technical advantages of certain embodiments of the present disclosure include providing multiple communication methods from a single source, which allows end user 12 to communicate faster and more effectively. Other technical advantages include advanced synergistic communication and monitoring methods by combining multiple communication and monitoring methods within a single source, which allows end user 12 to communicate faster and more effectively. Other technical advantages of the present disclosure include monitoring the status of end points in real time, which allows end user to be more productive since end user 12 does not have to track the status of individuals or objects.

According to the illustrated embodiment, system 10 provides services such as communication sessions to end points, such as access terminal 14. A communication session refers to an active communication between end points. Information may be communicated during a communication session. Information may include voice, data, text, audio, video, multimedia, control, signaling, and/or other information. Communication sessions may be referred to as collaboration sessions. Information may be communicated in packets, each comprising a bundle of data organized in a specific way for transmission.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, mobile IP), or other standards. In some embodiments, system and unified personal communicator may utilize various protocols, such as SIP, IMAP, SOAP, HTTP, HTTPS, etcetera.

According to the illustrated embodiment, end user 12 may represent any person utilizing access terminal 14. For example, end user 12 may utilize access terminal 14 to log on to unified personal communicator 16 to communicate and collaborate with other end users 12 or to view the status of buddies on end user's unified personal communicator 16. A buddy may be any end point, such as end user 12, sensor 80, resource 82, web item 84, or any other end point that is connected to the communication network that end user 12 may subscribe to via unified personal communicator 16. End user 12 may monitor the status of each buddy displayed on unified personal communicator 16. Sensors 80, resources 82, and web items 84 are explained below in more detail.

According to the illustrated embodiment, access terminal 14 may represent any suitable device operable to communicate with a communication network 30. For example, end user 12 may use access terminal 14 to communicate with communication network 30. Access terminal 14 may include a Macintosh, a workstation, a laptop, a UNIX-based personal digital assistant, a general purpose personal computer (PC), computer, a server computer, a cellular telephone, a mobile handset, and/or any other device operable to communicate with system 10. Access terminal 14 may be a mobile or fixed device.

System 10 includes a communication network 30. In general, communication network 30 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding. Communication network 30 may implement any suitable communication protocol for transmitting and receiving data or information within communication system 10.

System includes servers 52, 54, 56, 58, 60, such as presence server 52, call manager server 54, directory server 56, voicemail server 58, and meeting manager server 60. These particular servers are explained in more detail below. In one embodiment, one or more servers 52, 54, 56, 58, 60 may be physically distributed such that each server, or multiple instances of each server, may be located in a different physical location geographically remote from each other. In other embodiments, one or more servers may be combined and/or integral to each other. One or more servers may be implemented using a general-purpose personal computer (PC), a Macintosh, a workstation, a UNIX-based computer, a server computer, or any other suitable processing device. In some embodiments, servers are operable to provide security and/or authentication for end users attempting to log on to unified personal communicator 16. Servers 52, 54, 56, 58, 60 may further comprise a memory. The memory may take the form of volatile or non-volatile memory including, without limitation, magnetic media, optical media, random access memory (RAM), read-only memory (ROM), removable media, or any other suitable local or remote memory component.

Unified personal communicator 16 represents an application that includes a single interface, such that the single interface allows end users 12 access to voice, video, e-mail, instant messaging, presence data, and web conferencing. Unified personal communicator 16 represents any logic, element, or object that streamlines the communication experience of end user 12 by providing end user 12 access to voice, video, e-mail, voice mail, instant messaging, presence data, and/or web conferencing in a single interface, which allows for multimedia collaboration between two or more end users that may be located anywhere in the world. Presence data may include any type of data that indicates status of end point or data associated with end point, such as call status, user status, temperature, motion sensor data, electronic auction status, flight status, package delivery status, stock price status, etcetera. Status may be any status associated with an end point. Status may indicate available, busy, idle, on phone, away, time remaining, price, temperature, etcetera. Unified personal communicator 16 may include a SIP softphone element 18 and a hardphone control element 20. Unified personal communicator 16 may communicate with presence server 52, call manager server 54, directory server 56, voicemail server 58, and meeting manager server 60 in order to adequately provide presence data and communication methods to end user 12. Unified personal communicator 16 allows data to be exchanged between access terminal 14 and any number of selected elements within communication system 10.

Unified personal communicator 16 supports advanced communication methods for end users 12 to communicate more effectively. Traditionally, end users 12 may have used several different conventional communication devices and applications to communicate with other end users 12. Each of these conventional devices and applications may have different rules, methods, and directories. Unified personal communicator 16 simplifies the communication experience by providing the capabilities of the various conventional devices and applications into a single location, such that unified personal communicator 16 provides end user 12 with quick and easy access to a unified set of rules, methods, and directories to facilitate communication.

For example, end user 12 may search directories to locate a colleague, family member, or customer to add to end user's buddy list. Within unified presence communicator 16, end user 12 may monitor the status and availability of other end users 16 by utilizing the dynamic presence data transmitted to unified personal communicator 16. Status may be any status associated with an end point or buddy. Status may indicate available, busy, idle, on phone, away, time remaining, price, temperature, etcetera. After viewing the status of a particular buddy, end user 12 may choose a communication method from unified personal communicator 16 to communicate with other buddies based on their status.

For example, end user 12 may choose to send an instant message rather than call a particular buddy because unified personal communicator 16 indicates that this buddy is currently on the phone. Additionally, end user 12 may utilize unified personal communicator 16 to initiate a conference session, such as a video conference session, with other end users 12 that are shown as available on unified personal communicator 16. Additionally, unified personal communicator 16 allows end user 12 to select a method of communication of how end user 12 prefers to be contacted, such as voice, video, instant messaging, or e-mail. Additionally, unified personal communicator 16 allows end user 12 to view how other end users 12 prefer to be contacted. End user 12 may access a plurality of different communication methods from unified personal communicator 16 to communicate most efficiently with other end users 12. By adding and removing communication methods throughout a collaboration session as needed, unified personal communicator 16 maximizes the communication efficiency and efficacy between end users 12.

Unified personal communicator 16 supports advanced communication methods for end users 12 to reduce communication delays with other end users 12. Unified personal communicator 16 dynamically updates availability status of end users 12 in real time by displaying user status and call status for each end user 12. Unified personal communicator 16 allows end user 12 to set user status, such that other end users 12 will know when end user 12 is available.

Additionally, unified personal communicator 16 automatically updates user status based on presence events or presence data. Unified personal communicator 16 may communicate with presence server 52 to transmit user status of end user 12. Unified personal communicator 16 may also communicate with presence server 52 to receive user status updates of buddies that end user 12 has subscribed to. User status may represent end user 12 as online, offline, available, busy, away, idle, or any other useful user status. Unified personal communicator 16 automatically updates call status of end user 12 by indicating if end user 12 is currently using a voice application, such as a softphone or a hardphone. Unified personal communicator 16 may communicate with presence server 52 to receive call status of end user 12. Presence server receives data of end user call status from call manager server 54, which monitors call state of end points. Unified personal communicator 16 may also communicate with call presence server 52 to receive call status of other end users 12 that end user 12 has subscribed to. User status and call status of end users 12 are updated in real time. Knowing when other end users 12 are available helps reduce communication delays between end users 12, such that productivity of end users 12 is increased.

Unified personal communicator 16 supports advanced communication methods for end users 12 to effectively monitor status and presence data of sensors 80, resources 82, websites, other end users 12, or any end point. Unified personal communicator 16 allows end users 12 to view real time availability status and presence data of sensors 80, resources 82, web items 84, other end users 12, or any end point. For example, end user 12 may use unified personal communicator 16 to monitor the availability of a conference room within end user's building, the status of a package being shipped to end user, the temperature of a thermometer at a remote location, the price of an auction, or the availability of another end user 12. Sensors 80, resources 82, and web items 84 are described below in more detail. Presence data associated with a sensor 80, resource 82, or web item 84 may be transmitted to presence server 52. Presence server 52 may aggregate or use logic to combine the status of multiple sensors 80, resources 82, or web items 84. Alternatively, unified personal communicator 16 may aggregate or use logic to combine the status of multiple sensors 80, resources 82, or web items 84. Presence data associated with sensors 80, resources 82, or web item 84 may be received by unified personal communicator 16 from presence server 52, such that end user 12 may view user status of sensors 80, resources 82, and web items 84 in real time.

Unified personal communicator 16 allows end user 12 to customize settings to enhance communications and productivity. End users 12 may create customized messages to display to other end users 12, such as out of office alerts. End users 12 may customize various elements of the unified personal communicator 16, such as changing the colors that are associated with end user 12 being available, idle, or busy. For example, end user 12 may select green for available, yellow for idle, and red for busy. End users 12 may enable real time actions to occur based on a real time triggering event. For example, if end user 12 is subscribed to a thermometer, then end user 12 may instruct unified personal communicator 16 to send a message to end user 12 when the thermometer goes below freezing, such that message may comprise “cover up the plants because it's freezing outside!” Unified personal communicator 16 allows end user 12 to alter privacy settings, such that only certain data is displayed. End users 12 may also restrict access to other end users 12, such that only specified end users 12 may subscribe to them.

In operation of an example embodiment, end user 12 may run unified personal communicator 16 on access terminal 14. End user 12 may enter user name and password into unified personal communicator 16. Unified personal communicator 16 may register with presence server 52, call manager server 54, directory server 56, voicemail server 58, and meeting manager server 60, such that each server may verify and authenticate end user 12. End user 12 may search among one or more directory servers 56 via unified personal communicator 16 for other end users 12, sensors 80, resources 82, and web items 84. Once end user 12 has found the unique ID associated with the sought after end user 12, sensor 80, resource 82, or web item 84, then end user 12 may subscribe to this end point, such that end point becomes a buddy displayed on interface of unified personal communicator 16. End user 12 may utilize unified personal communicator 16 to communicate by voice, instant messaging, video, or e-mail to one or more end users 12 that this particular end user 12 has subscribed to. End user 12 may monitor the status of one or more end users 12, sensors 80, resources 82, or web items 84 via unified personal communicator 16. Presence data is exchanged between unified personal communicator 16 and presence server 52. Presence data associated with end user 12 may be transmitted to presence server 52, and presence server 52 may update the user status of this particular end user 12 in real time to other end users 12 that are subscribed to this particular end user 12. Presence data associated with other end users 12 may be received by unified personal communicator 16 from presence server 52, such that end user 12 may view user status of other end users 12 in real time. Similarly, call status of end user 12 may be transmitted to call manager server 54, and call manager server 54 may send a call status update to presence server 52. Presence server 52 may merge the user status and call status to determine the availability status for a particular end user 12. Presence data associated with a sensor 80, resource 82, or web item 84 may be transmitted to presence server 52. Presence server 52 may aggregate or use logic to combine the status of multiple sensors 80, resources 82, or web items 84. Alternatively, unified personal communicator 16 may aggregate or use logic to combine the status of multiple sensors 80, resources 82, or web items 84. Presence data associated with sensors 80, resources 82, or web items 84 may be received by unified personal communicator 16 from presence server 52, such that end user 12 may view user status of sensors 80, resources 82, and web items 84 in real time.

Softphone element 18 is an element that allows end user 12 to establish a call session using unified personal communicator 16 to another end user 12 via the Internet, rather than using a conventional dedicated telephone. Call session may include a telephone call or a video call. For example, end user 12 may initiate a conference call via unified personal communicator 16 by using softphone element 18.

Hardphone control element 20 is an element that allows end user 12 to control a conventional dedicated telephone by using unified personal communicator 16. For example, end user 16 may initiate a conference call via unified personal communicator 16 by using a conventional dedicated telephone.

Web item tracking element 22 may utilize presence data associated with web item 84. In one embodiment, web item tracking element 22 is located within unified personal communicator 16. Web item tracking element 22 allows end users 12 to subscribe to web item 84. End user 12 may search for web item 84 on directory server 56 by using unified personal communicator 16. End user 12 may subscribe to selected web item 84 through directory server. Alternatively, end user 12 may subscribe to web item 84 by dragging and dropping a uniform resource locator (URL) of web item 84 into buddy list of unified personal communicator 16. For example, end user 12 may search directory server for a stock symbol and end user 12 may subscribe to a particular stock. End user may also visit an auction on an auction web site that end user would like to monitor. End user may drag and drop the associated URL of the particular auction into buddy list of unified personal communicator 16. Web item tracking element 22 also allows end user 12 to subscribe to web item 84 by manually entering a URL associated with web item 84 in buddy list.

Web item tracking element 22 may receive presence data originating from web item 84. Web item tracking element 22 may have logic or template for extracting relevant presence data from web item 84. Web item tracking element 22 may automatically extract relevant presence data from web item 84 based on logic or template. For example, web item tracking element 22 may extract stock price data and percentage of increase/decrease from a web item 84 associated with a stock URL. Web item tracking element 22 may extract time remaining, number of bids, current bid amount, or buy out price from a web item 84 associated with an auction URL. Web item tracking element 22 may extract estimated date of delivery and current location of a package from web item associated with a package tracking URL. Web item tracking element 22 may extract any relevant presence data from any type of web item 84.

Web item tracking element 22 may display status of web item 84 to end user 12. Web item tracking element 22 allows end user 12 to customize display of buddy representing web item 84, such that features being displayed may change based on the received presence data. For example, end user 12 may set color range of color displayed for stock buddy, such that stock that has depreciated more than ten percent displays red, stock that has depreciated between zero and ten percent displays yellow, stock that has appreciated between zero and ten percent displays blue, and stock that has appreciated more than ten percent displays green. Web item tracking element 22 allows status of sensor buddy to display data associated with web item 84. For example, stock web item buddy may display the numerical representation of the price of the stock. Auction web item buddy may display the numerical representation of time remaining in auction and the current price of the auction. In addition, data displayed by tool tip over buddy sensor may change based on presence data originating from web item 84. This same technique can be applied to any type of web item 84 to display any feature associated with web item 84.

Web item tracking element 22 allows end user 12 to create triggering events based on presence data originating from web item 84. For example, when stock buddy reaches fifty dollars, web item tracking element 22 may send instant message to end user 12 stating “XYZ has hit fifty dollars! Please click the following URL to buy or sell your shares” and containing a URL link. Web item tracking element 22 also allows end user 12 to send a command to web item 84. End user 12 may manually send a command to web item 84 or end user 12 may use a triggering event to automatically send command to web item 84. For example, when stock hits fifty dollars, end user can see this number displayed and send an instant message to stock buddy stating “buy 500 shares”. Web item 84 is operable to process instant message and buy 500 shares of the stock associated with the stock buddy.

In another example, end user 12 may create a triggering event to send a command to a different broker buddy when stock buddy reaches fifty dollars. If stock reaches fifty dollars, then web item tracking element 22 can automatically send an instant message to broker to buy five hundred shares of stock associated with the stock buddy. The command may be any type of communication method for communicating with web item 84. Command communication may use any appropriate protocol, such as SIP or HTTP, to communicate with web item 84. Web item tracking element 22 also allows end user 12 to create a single buddy or buddy group to represent the status of multiple web item 84.

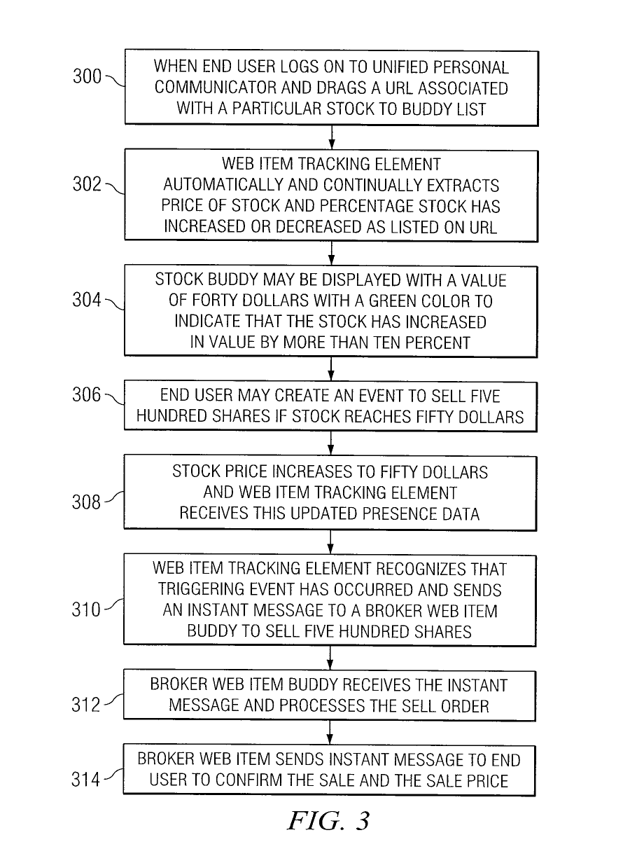

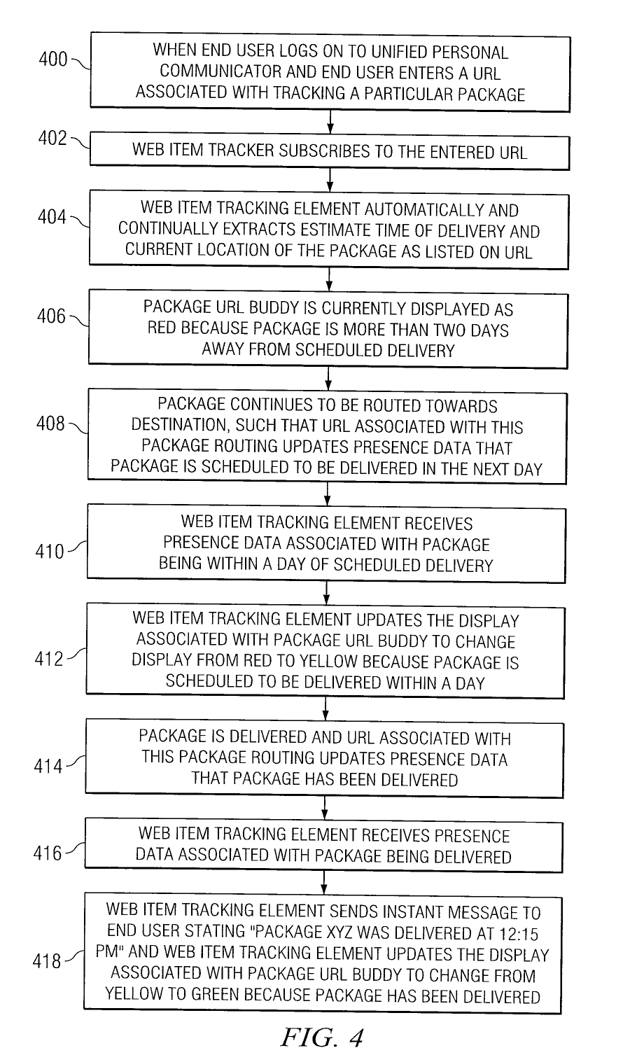

Web item tracking element 22 may merge the presence data associated with multiple web items 84 to determine a single status associated with the web item 84. For example, end user 12 may want to track the price of a retail item from multiple websites associated with multiple retailers. End user 12 can create a buddy associated with this retail item and subscribe to multiple web items 84 associated with different retailer websites selling the retail item, such that the buddy may display average price, lowest price, and highest price of the retail item. Web items 84 are described below in more detail. The operations and processes associated with web item tracking element 22 are described below with reference to FIGS. 3 and 4.

It is critical to note that unified personal communicator 16 and web item tracking element 22 may include any suitable elements, hardware, software, objects, or components capable of effectuating their operations or additional operations where appropriate. Additionally, any one or more of the elements included in unified personal communicator 16 and web item tracking element 22 may be provided in an external structure or combined into a single module or device where appropriate. Moreover, any of the functions provided by unified personal communicator 16 and web item tracking element 22 may be offered in a single unit or single functionalities may be arbitrarily swapped between unified personal communicator 16 and web item tracking element 22. The embodiment offered in FIG. 1 has been provided for purposes of example only. The arrangement of elements (and their associated operation(s)) may be reconfigured significantly in any other appropriate manner in accordance with the teachings of the present disclosure.

Presence server 52 is an object that may collect presence data from unified personal communicator 16 regarding status of an end point. Presence data may include any data related to status of end point, such as when end user becomes idle. Additionally, presence server 52 may collect presence data from sensors 80, resources 82, and web items 84. Presence server 52 records and updates the presence status of all end points. Presence server 52 may be responsible for consolidating and disseminating the presence data of all end points. For example, when presence server 52 receives new presence data from an end point, presence server 52 sends this updated information to all end users 12 that are subscribed to that particular end point. Presence server 52 also collects data about an end user's communications capabilities, such as whether end user 12 is currently on phone or if end user 12 has certain applications enabled on access terminal 14, such as videoconferencing. Presence server 52 may also manage instant message communication between end points. In one embodiment, instant messaging between two end users 12 may utilize call signaling over SIP that is sent through presence server 52. Presence server 52 may be operable to communicate instant messages with different proprietary protocols. Presence server 52 may receive user status from unified personal communicator 16 and call status from call manager server 54. User status updates may be a result of end user 12 manually changing user status to available, busy, out of office, away, do not disturb, or a custom message. User status may also change when end user 12 logs on and off unified personal communicator 16. Call status may indicate if end user 12 is on or off a softphone or hardphone. Presence server 52 may determine availability status of end user 12 by merging the user status data and the call status data. Presence server 52 may broadcast each end user's availability status to all other end users 12 who subscribe to that particular end user 12.

Call manager server 54 is an object that may provide call processing for calls from any end point, such as unified personal communicator 16. Call manager server 54 may manage and process various communications from and to unified personal communicator 16, such as video and/or audio calls. Call manager server 54 allows different end points to communicate with call signaling, such as SIP. Call manager server 54 may monitor call status for each end point and send the call status to presence server 52, such that presence server 52 may monitor availability of end points.

Directory server 56 is an object that may store the data for all end points in system 10. Each end point is associated with a unique identification in directory server 56. Each end point may include other data fields to describe end point, such as first name, last name, buddy name, address, floor number, conference room number, device name, telephone number, etcetera. Unified personal communicator 16 may search for an end point to subscribe for presence events by using search terms to find the proper end point listed in directory server 56. Directory server 56 entries may include end users 12, access terminals 14, sensors 80, resources 82, and web items 84. Directory server 56 may include specialized databases that are optimized for a high amount of writes, updates, queries, and searches.

Voicemail server 58 is an object that consolidates voicemails, such that end users 12 may access voicemail through unified personal communicator 16. For example, unified personal communicator 16 may display a list of voicemails associated with a name of who left the voicemail. End user 12 may select to listen to any voicemail from the list of voicemails.

Meeting manager server 60 is an object that may provide voice, video, and web conferencing capabilities to unified personal communicator 16. Unified personal communicator 16 may utilize meeting manager server 60 to allow end user 12 to participate in an audio conference call, video conference call, or a web collaboration conference call, such that end user 12 may whiteboard and share files.

Sensors 80 are any objects that may monitor and record presence data or any other data. Sensors 80 may include thermometers, thermostats, motion sensors, central processor unit sensors, light switches, microphones, etcetera. Sensors 80 may be registered on directory server 56, such that end users 12 may search and subscribe to sensors 80. Sensor 80 may register on directory server 56 when sensor 80 is connected to network 30. Sensors 80 may transmit data to presence server 52 or end points. Sensors 80 may receive one or more commands originating from unified personal communicator 16. Sensors 80 may process the one or more commands. For example, unified personal server 16 may command a central processor unit to restart or command a thermostat to turn on air conditioning. Unified personal communicator 16 may communicate with presence server 52 to receive current presence data and real time updates of presence data associated with sensors 80. Sensors 80 may communicate with unified personal communicator 16 in addition to sending presence data. One or more sensors 80 may be associated with resource 82, such that sensors 80 may provide presence data associated with resource 82.

Resources 82 are any physical objects that may be finite in number that are utilized or reserved by end users 12. Resources 82 are any objects that end user 12 may want to reserve when unavailable, such that end user 12 may want to use resource 82 when available. Additionally, resources 82 are any objects that end user 12 may want to know the status of before end user 12 attempts to access resource 82. Resources 82 may be monitored with presence data. Resources 82 may include any object with a finite number available for end users 12 to utilize, such as equipment, conference rooms, library books, etcetera. Equipment may include any equipment that end user 12 may want to use, such as white boards, televisions, DVD players, radios, projectors, etcetera. Resources 82 may be registered on directory server 56, such that end users 12 may search and subscribe to resources 82. End users 12 subscribed to resources 82 may be notified when presence data associated with resources 82 is updated. Resource 82 may or may not be connected to network 30, but methods are readily available to communicate presence data and/or resource state to presence server 52. For example, a library book may not be connected to network 30, but a librarian may use a scanning device to scan bar code associated with book to scan in the library book, such that the scanned data or book status is sent to presence server 52. Additionally, an inventory system may track the status of library book and send presence data or status associated with library book to presence server 52. One or more sensors 80 may be associated with a particular resource 82, such that presence server 52 may monitor the status of resource 82. For example, a conference room may include a light sensor, a microphone sensor, and a motion sensor, such that each of these sensors 82 are sending presence data to presence server 52 in real time.

In one embodiment, presence server 52 may merge the presence data associated with sensors 80, resources 82, or web items 84. For example, presence server 52 may merge the presence data from multiple web sites to determine the status of consumer good associated with these web sites. Alternatively, a separate server or unified personal communicator 16 may merge the presence data associated with sensors 80, resources 82, or web items 84.

Web items 84 are any objects that are associated with a URL. Web items 84 may include flight data, online auction data, price of online retail product data, stock data, package routing data, etcetera. Web item 84 may be registered on directory server 56, such that end users 12 may search and subscribe to web item 84. Alternatively, web item 84 may be subscribed to by entering a URL address as the unique identifier associated with a buddy. Web items 84 may transmit data to presence server 52 or end points. Web items 84 may receive one or more commands originating from unified personal communicator 16. Web items 84 may process the one or more commands. For example, unified personal server 16 may command a URL to bid on an auction item. Unified personal communicator 16 may communicate with presence server 52 to receive current presence data and real time updates of presence data associated with web item 84. Web item 84 may communicate with unified personal communicator 16 in addition to sending presence data.

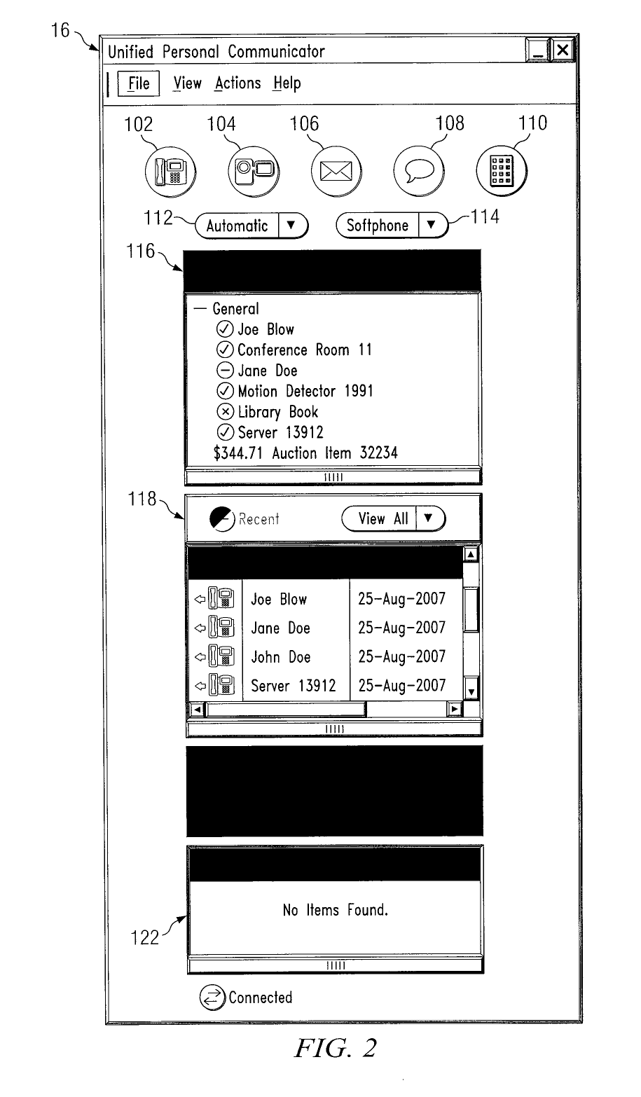

FIG. 2 is a simplified block diagram of an interface of unified personal communicator 16 in accordance with one embodiment of the present disclosure. This embodiment of interface displays a pull down menu for file, view, actions, and help. Interface allows end user to choose from several communication methods, including voice 102, video 104, e-mail 106, instant message 108, or dial pad 110. A user status pull down menu 112 allows end user 12 to manually select a user status or allow unified personal communicator 16 to automatically monitor user status. A communication preference pull down menu 114 allows end user to select the preferred method of communicating with other end users. Contacts 116 may be grouped into lists, such that lists contain buddies associated with that particular list. Buddies may include end points, such as other end users, resources, or sensors. Interface of unified personal communicator 16 may also display recent communication sessions 118 with buddies, such that details of communication sessions are displayed. Communication sessions may include voice, video, e-mail, or instant message. Search field 120 allows end user to search directory server 56 to locate buddies to subscribe to. Search field results 122 display any buddies that were located as a result of the search.

FIG. 3 is a simplified flowchart illustrating an example method for utilizing presence data associated with web item. The flowchart may begin at step 300 when end user logs on to unified personal communicator and drags a URL associated with a particular stock to buddy list.

At step 302, web item tracking element automatically and continually extracts price of stock and percentage stock has increased or decreased as listed on URL. At step 304, stock buddy may be displayed with a value of forty dollars with a green color to indicate that the stock has increased in value by more than ten percent. Stock buddy may display several values, such as number of shares end user owns, price of shares when bought by end user, current price of shares, etcetera. At step 306, end user may create an event to sell five hundred shares if stock reaches fifty dollars.

At step 308, stock price increases to fifty dollars and web item tracking element receives this updated presence data. At step 310, web item tracking element recognizes that triggering event has occurred and sends an instant message to a broker web item buddy to sell five hundred shares.

At step 312, broker web item buddy receives the instant message and processes the sell order. At step 314, broker web item sends instant message to end user to confirm the sale and the sale price.

FIG. 4 is a simplified flowchart illustrating an example method for utilizing presence data associated with web item. The flowchart may begin at step 400 when end user logs on to unified personal communicator and end user enters a URL associated with tracking a particular package.

At step 402, web item tracker subscribes to the entered URL. At step 404, web item tracking element automatically and continually extracts estimate time of delivery and current location of the package as listed on URL.

At step 406, package URL buddy is currently displayed as red because package is more than two days away from scheduled delivery. At step 408, package continues to be routed towards destination, such that URL associated with this package routing updates presence data that package is scheduled to be delivered in the next day. At step 410, web item tracking element receives presence data associated with package being within a day of scheduled delivery.

At step 412, web item tracking element updates the display associated with package URL buddy to change display from red to yellow because package is scheduled to be delivered within a day. At step 414, package is delivered and URL associated with this package routing updates presence data that package has been delivered. At step 416, web item tracking element receives presence data associated with package being delivered. At step 418, web item tracking element sends instant message to end user stating “Package XYZ was delivered at 12:15 pm” and web item tracking element updates the display associated with package URL buddy to change from yellow to green because package has been delivered.

Some of the steps illustrated in FIGS. 3 and 4 may be changed or deleted where appropriate and additional steps may also be added to the flowcharts. These changes may be based on specific communication architectures or particular interfacing arrangements and configurations of associated elements and do not depart from the scope or the teachings of the present disclosure. The interactions and operations of the elements within unified personal communicator 16 and web item tracking element 22, as disclosed in FIGS. 3 and 4, have provided merely one example for their potential applications. Numerous other applications may be equally beneficial and selected based on particular networking needs.

Although the present disclosure has been described in detail with reference to particular embodiments, communication system 10 may be extended to any scenario in which end user 12 is utilizing unified personal communicator 16 to monitor the status and/or communicate with end points. Additionally, although communication system 10 has been described with reference to a number of elements included within unified personal communicator 16, these elements may be rearranged or positioned anywhere within communication system 10. In addition, these elements may be provided as separate external components to communication system 10 where appropriate. The present disclosure contemplates great flexibility in the arrangement of these elements as well as their internal components. For example, in an alternative embodiment interface for unified personal communicator 16 may include different elements or the same elements arranged differently. Moreover, although FIGS. 1 and 2 illustrate an arrangement of selected elements, numerous other components may be used in combination with these elements or substituted for these elements without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus, comprising:
a unified personal communicator utilized by an end user; and
a web item tracking element operable to:
subscribe to a web item;
extract presence data from the web item;
receive the presence data originating from the web item;
update status associated with the web item based on the presence data; and
display the updated status associated with the web item.

2. The apparatus of claim 1, wherein the web item tracking element is further operable to:
receive an event condition from the end user, wherein the event condition is based on the presence data originating from the web item; and
generate an event if event condition is satisfied.

3. The apparatus of claim 2, wherein the event is a command destined to a selected one of the web item and a second web item.

4. The apparatus of claim 3, wherein the web item is operable to process the event.

5. The apparatus of claim 2, wherein the event is an instant message to the end user.

6. The apparatus of claim 1, wherein the web item is operable to register with a directory server.

7. The apparatus of claim 1, wherein the web item is one or more web items being selected from a group of web items consisting of:
a) flight data;
b) auction data;
c) price of retail product data;
d) stock data; and
e) package routing data;

8. The apparatus of claim 1, wherein the unified personal communicator is further operable to customize the displayed updated status of the web item based on the presence data.

9. The apparatus of claim 1, wherein the web item is associated with a URL.

10. A method, comprising:
subscribing to a web item;
extracting presence data from the web item;
receiving the presence data originating from the web item;
updating status associated with the web item based on the presence data; and
displaying the updated status associated with the web item.

11. The method of claim 10, further comprising:
receiving an event condition from the end user, wherein the event condition is based on the presence data originating from the web item; and
generating an event if event condition is satisfied.

12. The method of claim 11, wherein the event is a command destined to a selected one of the web item and a second web item.

13. The method of claim 12, wherein the web item is operable to process the event.

14. The method of claim 11, wherein the event is an instant message to the end user.

15. The method of claim 10, wherein the web item is operable to register with a directory server.

16. The method of claim 10, wherein the web item is one or more web items being selected from a group of web items consisting of:
a) flight data;
b) auction data;
c) price of retail product data;
d) stock data; and
e) package routing data;

17. The method of claim 10, further comprising customizing the displayed updated status of the web item based on the presence data.

18. The method of claim 10, wherein the web item is associated with a uniform resource locator (URL).

19. Logic encoded in one or more tangible media for execution and when executed operable to:
subscribe to a web item;
extract presence data from the web item;
receive the presence data originating from the web item;
update status associated with the web item based on the presence data; and
display the updated status associated with the web item.

20. The Logic of claim 19, further operable to:
receive an event condition from the end user, wherein the event condition is based on the presence data originating from the web item; and
generate an event if event condition is satisfied.
